(19) United States
(12) Patent Application Publication
(10) Pub. No.: US 2009/0110609 A1
(43) Pub. Date: Apr. 30, 2009

(54) Pressurization Device And Air Treatment System For A Shelter

(76) Inventor: Edward V. Roscioli, Easton, PA (US)

Correspondence Address: MICHAEL BEST & FRIEDRICH LLP, 100 E WISCONSIN AVENUE, Suite 3300, MILWAUKEE, WI, 53202, US

(21) Appl. No.: 11/791,359

(22) PCT Filed: Nov. 22, 2005
(86) PCT No.: PCT/US05/42706

§ 371 Date: May 22, 2007

Related U.S. Application Data
(60) Provisional application No. 60/629,982, filed on Nov. 22, 2004.

(51) Int. Cl. B01D 53/62; G05D 16/00

(52) U.S. Cl. 422/113; 422/242; 422/112; 422/226; 422/168

(57) ABSTRACT

A pressurization device is for a flexible enclosure disposable within an environment having air at a pressure and configured to define an interior chamber having a sufficient volume to entirely contain at least one person and containing air. The device includes a gas generator configured to generate and release a gas into the enclosure chamber such that the enclosure air pressure is increased or maintained above the environment air pressure to prevent entry of environment air into the enclosure chamber. The generator is preferably configured to generate the gas by a chemical reaction, and preferably includes a quantity of at least one reactant, such as sodium nitrate, sulfuric acid or ammonium chloride, and initiates chemical reaction of the reactant to generate the gas. Furthermore, the pressurization device is preferably incorporated into an air treatment system including an oxygen generator that generates and discharges oxygen into the enclosure chamber.

The present invention relates to shelter systems for humans, and more specifically to systems and devices for providing breathable air for shelters used for protection from chemical, biological and radiological agents.

Political and criminal events in the early 21^{st} Century have raised the threat of a terrorist attack by “weapons of mass destruction”, such as chemical, biological or radiological agents, to an unprecedented level. As such, systems for protection of persons from such attacks have become highly desirable.

### SUMMARY OF THE INVENTION

In one aspect, the present invention is a pressurization device for a flexible enclosure, the enclosure being disposeable within an environment having air at a pressure and configured to define an interior chamber, the chamber having a sufficient volume to entirely contain at least one person and containing air at a pressure. The pressurization device comprises a gas generator configured to generate a gas and to release the gas into the enclosure chamber such that the enclosure air pressure is increased to a value greater than the value of the environment air pressure and/or is maintained at a value greater than the environment air pressure value. As such, the generated gas substantially prevents entry of environment air into the enclosure chamber.

In another aspect, the present invention is an air treatment system for an enclosure, the enclosure being disposeable within an environment having air at a pressure and configured to define an interior chamber having a sufficient volume to entirely contain at least one person, the enclosure chamber containing air at a pressure. The air treatment system comprises an oxygen generator configured to generate oxygen and to discharge oxygen into the enclosure chamber and a gas generator. The gas generator is configured to generate a pressurizing gas and to release the gas into the enclosure chamber. As such, the enclosure air pressure is increased to a value greater than the value of the environment air pressure and/or maintained at a value greater than the environment air pressure value so as to substantially prevent entry of environment air into the chamber.

In a further aspect, the present invention is an oxygen generator device for a flexible enclosure, the enclosure being disposeable within an environment having air and configured to define an interior chamber having a sufficient volume to entirely contain at least one person and containing air. The oxygen generator device comprises a housing having an interior chamber and a release port, the port being fluidly connected with the interior chamber and fluidly communicable with the enclosure chamber. A quantity of an oxygen-producing material is removably disposeable within the housing chamber and is configured to generate oxygen by spontaneous chemical reaction. The housing is configured such that the oxygen generated by the material flows from the housing chamber, through the housing opening and into the enclosure chamber. Further, a feeder device is configured to contain an amount of the oxygen-producing material and to controllably feed the material into the housing chamber.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a side elevational view of a pressurization device and air treatment system in accordance with the present invention, shown disposed within a shelter located in a building;

FIG. 2 is a schematic view of the pressurization device and air treatment system;

FIG. 3 is schematic view of a first variation of the pressurization device and air treatment system;

FIG. 4 is schematic view of a second variation of the pressurization device and air treatment system;

FIG. 5 is schematic view of a third variation of the pressurization device and air treatment system; and

FIG. 6 is a perspective view of an exemplary feeder device for particulate reactants/substances for use with the pressurization device and/or other components of the treatment system.

### DETAILED DESCRIPTION OF THE INVENTION

As used herein, the term “connected” is intended to include direct connections between two members without any other members interposed therebetween and indirect connections between members in which one or more other members are interposed therebetween.

The present inventions relate to the devices and systems described in co-pending PCT Patent Application No. 2004/024951 filed on 31 Jul. 2004 and entitled “Shelter System and Associated Devices”, the entire contents of which are hereby incorporated by reference herein.

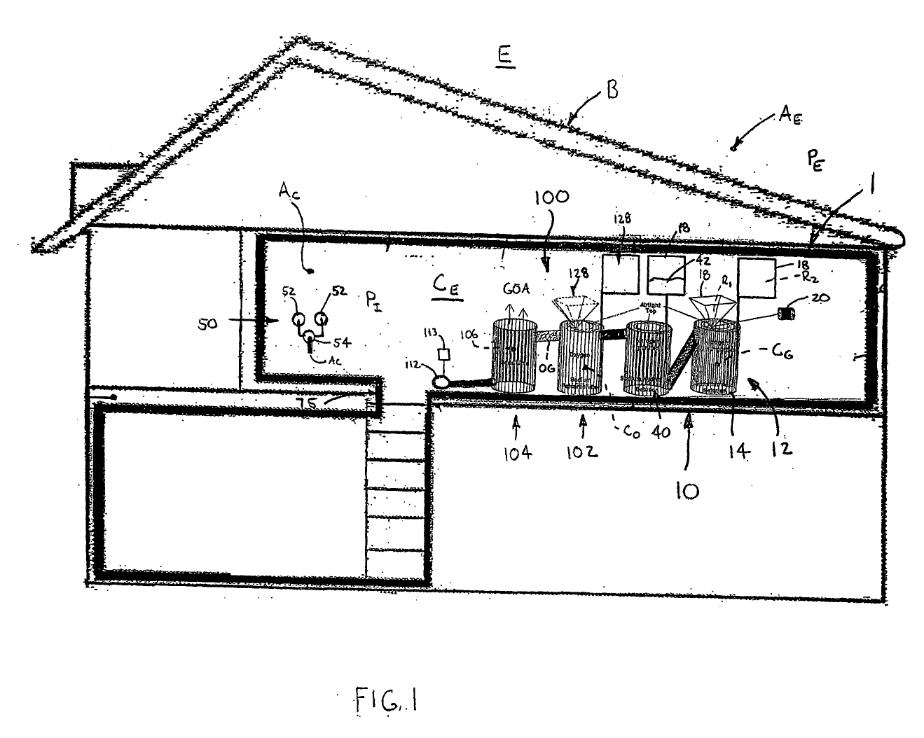

Referring now to the drawings in detail, wherein like numbers are used to indicate like elements throughout, there is shown in FIGS. 1-6, there is shown a presently preferred embodiment of a pressurization device 10 for a flexible enclosure 1, the enclosure 1 being disposeable within an environment E having air A_{E} at an exterior or environment pressure P_{E}. The enclosure 1 is configured to define an interior chamber C_{E} having a sufficient volume to entirely contain at least one and preferably a plurality of persons and containing air A_{C} at an interior or enclosure pressure P_{I}. The pressurization device 10 basically comprises a gas generator 12 configured to generate a gas G and to release the gas G into the enclosure chamber C_{E}. As such, the enclosure air pressure P_{I} is either increased to and/or is maintained above a value greater than the value of the environment air pressure P_{E} so as to substantially prevent entry of environment air A_{E} into the enclosure chamber C_{E}. Thereby, dangerous agents, such as chemical or biological agents, are prevented from entering the enclosure chamber C_{E} in the event of a breach of, or other damage to, the enclosure 1.

The gas generator 12 is configured to generate the gas G by a chemical reaction, and as such, preferably includes a quantity of at least one reactant R and is configured to initiate chemical reaction of the reactant R so as to generate the gas G. The gas G is preferably substantially composed of nitrogen or a mixture of oxygen and nitrogen, but may alternatively be any other relatively inert gas or gaseous mixture capable of being safely inhaled by humans.

Preferably, the gas generator 12 includes a housing 14 having an interior chamber C_{G} and a release port 16. The port 16 is fluidly connected with the generator interior chamber C_{G} and fluidly communicable with the enclosure chamber C_{E}, either directly or through an oxygen generator 102 and removal device 104, as discussed below. The quantity of reactant R is removably disposeable within the housing chamber C_{G} and is preferably configured to generate gas by spontaneous chemical reaction. Further, the housing 14 is configured such that the gas G generated by the reactant R flows from the housing chamber 14, through the release port 16 and into the enclosure chamber C_{E} (i.e., directly or indirectly). The generator housing 14 is preferably disposed completely within the enclosure chamber C_{E} as depicted (see e.g., FIG. 1), but may alternatively be at least partially disposed within the environment E and fluidly connected with the enclosure chamber C_{E} by appropriate means.

Further, the pressurization device 10 also preferably comprises a feeder device 18 configured to supply the reactant R to the generator housing chamber C_{G}, as described below. A pressure difference sensor 20 is configured to sense a difference AP between the interior, enclosure air pressure P_{I} and the exterior, environment air pressure P_{E}.

Furthermore, a controller 22 is coupled with the sensor 20 and is operatively connected with the feeder device 18. The controller 22 is configured to operate the feeder device 18 to supply reactant R to the housing chamber C_{G} when a value of sensed pressure difference ΔP is lesser than a predetermined minimum value. Additionally, the controller 22 is preferably further configured to cease operation of the feeder device 18, so as to stop the supply of reactant to the generator chamber C_{G}, when the pressure difference value is greater than a predetermined maximum value.

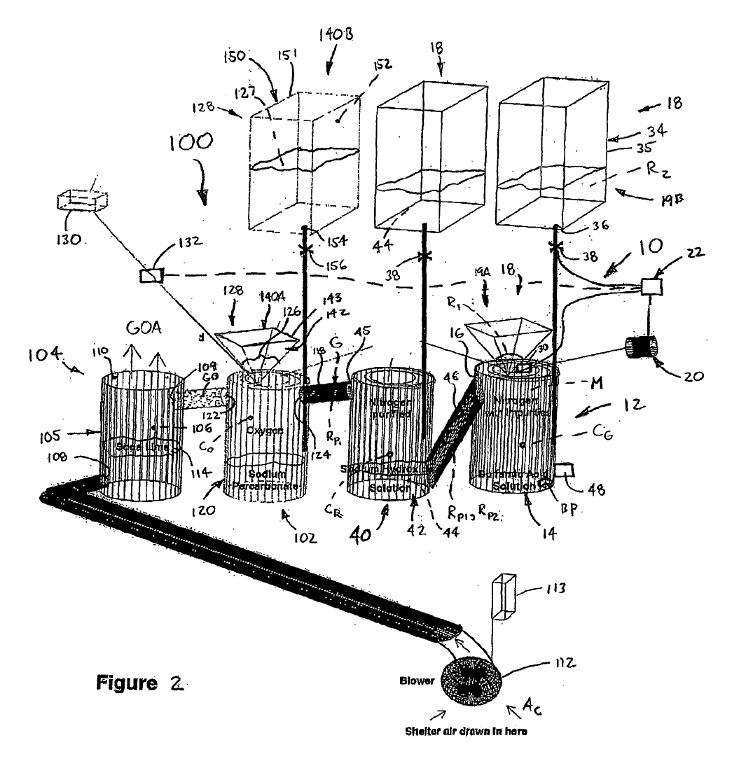

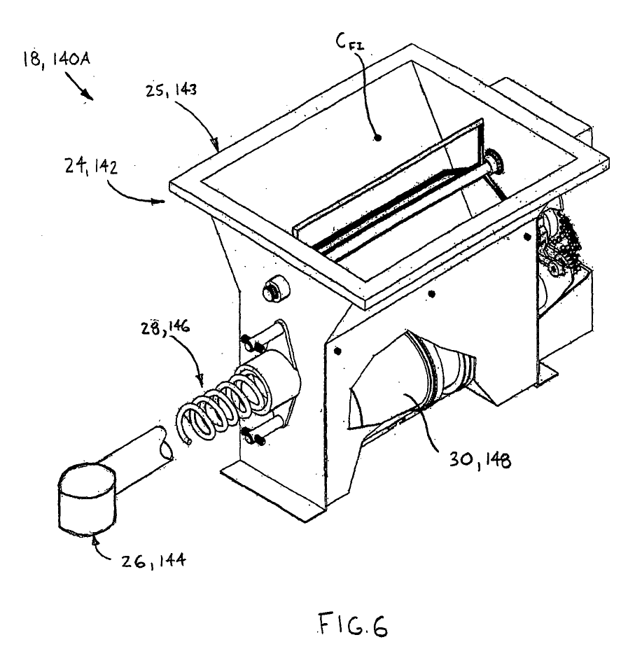

Referring to FIGS. 2-6, in one construction used with particulate or other solid reactants R, the feeder device 18 includes a housing 24, preferably a hopper 25, with a chamber CF configured to retain the particulate reactant R and having an opening 26 extending into the feeder chamber CF. As best shown in FIG. 6, a rotatable auger 28 is disposed at least partially within the feeder chamber C_{F1} and is configured to displace a portion of the reactant R toward or through the feeder opening 26. Further, a motor 30 is operatively connected with the auger 28 and is configured to rotate the auger 28 to controllably supply reactant R to the generator housing chamber C_{G}. In other words, the rotating auger 28 pushes portions of the reactant R so that the reactant R displaces toward and falls through the feeder opening 26, which is located with respect to the generator chamber C_{G} such that the reactant R is gravity fed (i.e., falls) into the chamber C_{G}. Most preferably, the particulate feeder 18 is a Volumetric Screw Feeder Model SF108-00 commercially available from Systems Engineering & Manufacturing of Oakdale, Calif.; however, the feeder 18 may alternatively be constructed as any other appropriate type of particulate feeder device. Further, the controller 22 is preferably a programmable logic controller or “PLC” electrically coupled with the motor 30, either directly or through a relay (not shown), although the controller 22 may be incorporated into the pressure difference sensor 20, such that the sensor 20 operates the motor 30.

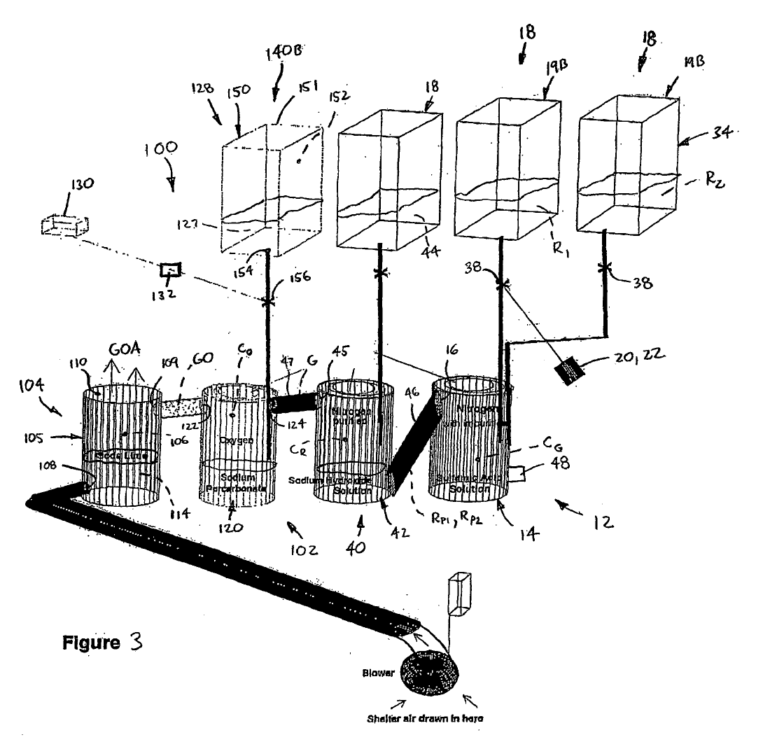

Referring now to FIGS. 2-4, in another construction used with liquid reactants R, the feeder device 18 includes a housing 34, preferably a tank 35, with a chamber C_{F2} configured to contain the liquid reactant R and a port 36 extending into the feeder chamber C_{F2}. An electromechanical valve 38 is configured to control flow through the port 36 so as controllably supply reactant R to the generator housing chamber C_{F2}. The port 36 is preferably located with respect to the generator housing chamber C_{G} such that fluid reactant R flows out the port 36 and is gravity fed (i.e., falls) into the chamber C_{G}. The valve 38 is preferably a latching solenoid valve, but may be any appropriate valve, such as for example, a motor-driven spindle valve. Further, the controller 22 is preferably a PLC electrically coupled with the valve 38, either directly or through a relay (not shown), although the controller 22 may be incorporated into the pressure difference sensor 20, such that the sensor 20 operates the valve 38, as indicated in FIG. 3.

Preferably, the gas generator 12 includes both a quantity of a first reactant R₁ and a quantity of a second reactant R₂, the gas-generating chemical reaction being initiated when at least a portion of the quantity of first reactant R₁ combines with at least a portion of the quantity of second reactant R₂. The first reactant R₁ is preferably supplied into the generator chamber C_{G} by the feeder device 18 as necessary to initiate gas generation, and the second reactant R₂ is removably disposed or placed within the generator chamber C_{G}, either automatically by a feeder device 18 (as depicted) or manually by a user, so as to maintain a certain amount or level thereof within the chamber C_{G}. As such, when the feeder 18 supplies a portion of the first reactant R₁ to the generator housing chamber C_{G}, the first reactant R₁ mixes with the second reactant R₂ to initiate chemical reaction of at least one of the two reactants R₁, R₂. Most preferably, the first reactant R₁ includes sodium nitrite (NaNO₂), in either particulate solid or liquid states, and the second reactant R₂ includes either sulfamic acid or ammonium chloride, preferably in a liquid solution. As such, when the solid or liquid first reactant R₁ is deposited into the liquid second reactant R₂, the gas-generating chemical reaction is initiated and the gas G is directly generated.

As depicted in FIG. 2, most preferably, particulate sodium nitrite first reactant R₁ is supplied by a first feeder device 19A, which is preferably a Volumetric Screw Feeder, at a rate of six pounds per hour (6 lb/hr) into a quantity of liquid sulfamic acid second reactant R₂ disposed within the generator chamber C_{G}. The preferred reaction process generates nitrogen gas G at a rate approximately three cubic feet per minute (3 ft³/min). Additionally, the liquid sulfamic acid R₂ is most preferably supplied by a second feeder device 19B, which preferably includes a liquid feeder with a control valve 38, as necessary to maintain a certain volume or amount of the reactant R₂ within the gas generator chamber C_{G}. Alternatively, as depicted in FIG. 3, both the first and second reactants R₁, R₂ may be supplied by a separate one of two liquid feeder devices 19A, in which case the first reactant R₁ is preferably a solution of sodium nitrite in water.

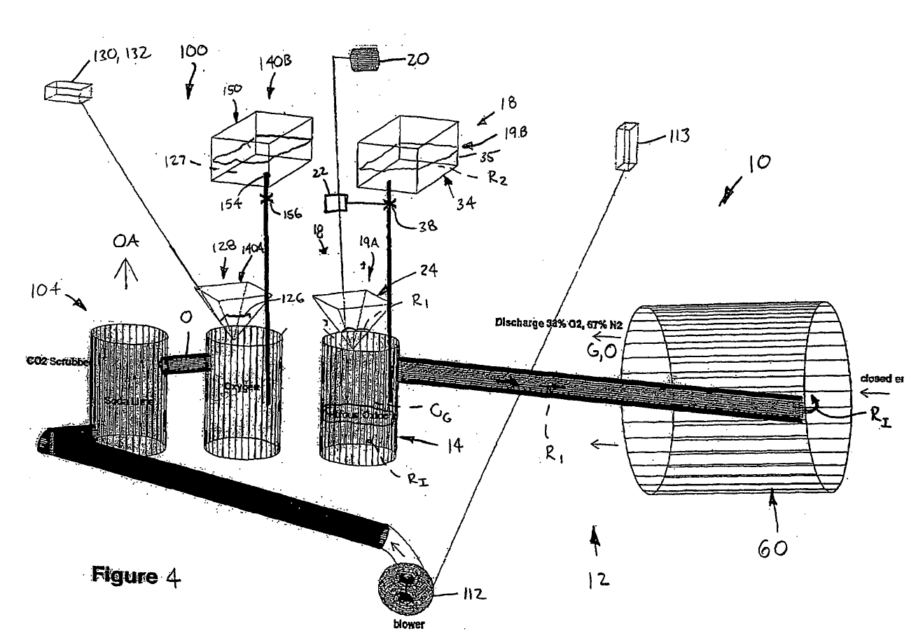

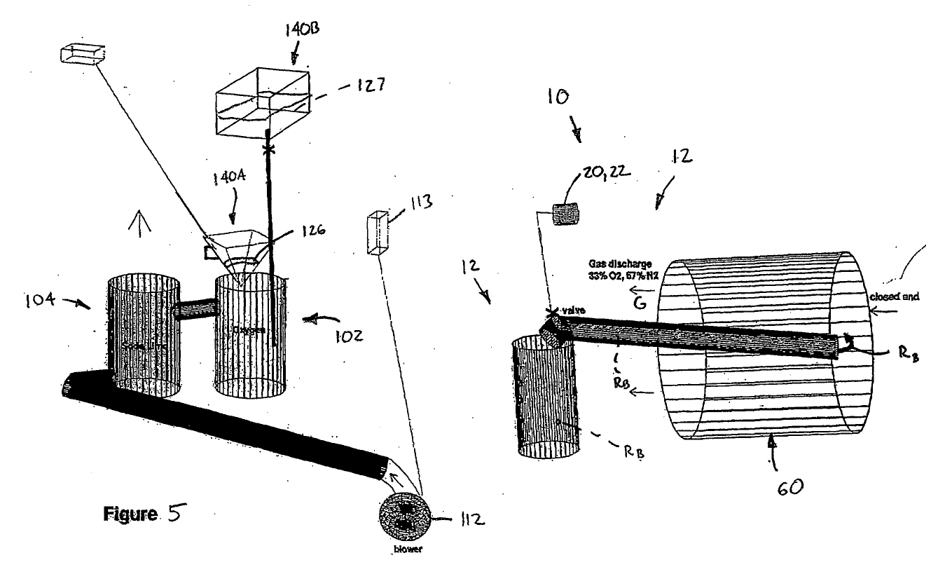

Referring to FIGS. 4 and 5, the gas generator 12 may be configured to produce an intermediate product R₁ and to decompose the intermediate product R₁ so as to produce the gas G. Such an intermediate product R₁ may be nitrous oxide and the gas G produced by decomposition of the nitrous oxide includes a mixture of oxygen and nitrogen. Preferably, the intermediate product R₁ is produced by generally the same process as described in U.S. Pat. No. 4,376,105 entitled “Process for Producing Nitrous Oxide”, the entire contents of which are hereby incorporated by reference herein. In such a case, the gas generator 12 further includes a decomposition device 60 configured to decompose the intermediate product R₁ into the gas G and one or more other decomposition products (e.g., oxygen), as depicted in FIG. 4. Further, the decomposition device 60 is preferably configured to function as basically described in U.S. Pat. No. 6,347,627 entitled “Nitrous Oxide Based Oxygen Supply System”, the entire contents of which are hereby incorporated by reference herein. As yet another alternative, the gas generator 12 may include a supply of a base substance R_{B}, such as liquid nitrous oxide, disposed within the generator chamber C_{G} and the decomposition device 60 fluidly connected with the chamber C_{G}, such that the generator 12 is configured to merely decompose the base substance R_{B} to produce the gas G, as shown in FIG. 5.

Referring to FIGS. 2 and 3, depending on the specific reactants R used in the gas generator 12, in certain cases the gas-generating chemical reaction produces a mixture product M including at least first and second reaction products RP₁, RP₂, the first reaction product RP₁ being the gas G and the second reaction product RP₂ being an undesired gas (e.g., nitrogen dioxide) or a solid or liquid suspended within the gas G. With such a gas generator 12, the pressurization device 10 preferably further includes a removal device 40 coupled with the gas generator 12 such that the generator 12 releases the product mixture M into the removal device 40. The removal device 40 is configured to remove or absorb the second reaction product RP₂ and to release the first reaction product RP₂ (i.e., the gas G) into the enclosure chamber C_{E}. Preferably, the removal device 40 includes housing 42 defining an interior chamber C_{R}, a quantity of reactive or absorbent material 44 disposed within the chamber C_{R}, and a discharge port 45. The removal device chamber C_{R} is fluidly connected with the generator chamber C_{G}, preferably by means of a fluid line or tube 46, such that the mixture product M flows directly from the gas generator 12 to the removal device 40 while remaining separate from the enclosure air A_{C}.

Further, the reactive/absorbent material 44 is configured to remove the second reaction product RP₂ from the mixture product M, the material 44 preferably being an alkali solution and most preferably a solution of sodium hydroxide. Thereafter, the separated first reaction product RP₁ (i.e., gas G) flows out the discharge port 45 and into the enclosure chamber C_{E}, either indirectly (as depicted) by means of another treatment device 102 (described below) or directly (not shown). Most preferably, the separated first reaction product RP₁ flows out the discharge port 45 and into at least one other removal device (not shown), which is preferably substantially identically constructed as described for the removal device 140, prior to flowing into the treatment device 102.

Furthermore, with any of the reactants R, the gas-generating chemical reaction further generates a reaction byproduct BP that accumulates within the generator housing chamber C_{G}. As such, the gas generator 12 preferably further includes a pump 48 configured to evacuate the byproduct BP from the housing chamber C_{G}. Preferably, the pump 48 is mounted to the generator housing 14 and conveys the byproduct BP to a waste receptacle (not shown). The waste pump 48 may be fixedly or removably mounted to the generator housing 14 and may be manually or electronically operated. One manually operated pump 48 suitable for this purpose is a 100 Series Polypropylene Manual Transfer Pump available from Galway Pumps of North East, Pa.

As best shown in FIG. 1, the pressurization device 10 preferably further comprises a pressure relief device 50 configured to release a portion of the enclosure air A_{C} into the environment E when the enclosure air pressure P_{I} is greater than a predetermined maximum value P_{Imax}. Preferably, the pressure relief device 50 includes two automatic relief valves 52 and a manual relief valve 54 separately fluidly connected with each one of the two automatic relief valves 52. Each automatic relief valve 52 is adjustable between an open configuration, at which air A_{C} is releasable from the enclosure chamber C_{E} to the environment E and a closed configuration. Further, each automatic valve 52 is configured to automatically adjust to the open configuration when the interior enclosure pressure P_{I} is greater than the predetermined maximum value P_{Imax} and to adjust to the closed configuration when the enclosure air pressure P_{Imax} is lesser than another predetermined pressure value P_{Imin}. The manual relief valve 54 is manually adjustable between an open configuration, at which each one of the two automatic relief valves 52 is fluidly connected with the enclosure chamber C_{E} and a closed configuration, at which the two automatic relief valves 52 are fluidly disconnected from the enclosure chamber C_{E}. With this structure, at least one automatic relief 52 is available to discharge air A_{C} to the environment E when the manual valve 54 is open and the other automatic valve 52 is “stuck” in the closed configuration. Additionally, when either (or both) automatic relief valve 52 is “stuck” in the open position, a user can adjust the manual valve 54 to the closed configuration to stop the flow of enclosure air A_{C} through the malfunctioning automatic valve(s) 52.

Referring again to FIGS. 2-6, there is shown a presently preferred embodiment of an air treatment system 100 for an enclosure 1 disposeable within an environment E having air at a pressure P_{E}. The enclosure 1 is configured to define an interior chamber C_{E} having a sufficient volume to entirely contain at least one person and contains air A_{C} at a pressure P_{I}, as discussed above. The air treatment system 100 basically comprises an oxygen generator 102, a gas generator 12 as described above, and a carbon dioxide removal device 104. The oxygen generator 102 is configured to generate and discharge oxygen O into the enclosure chamber C_{E}, preferably through the removal device 104 as discussed below, and is generally similar to the “oxygen generator 14” described in co-pending PCT Patent Application No. 2004/024951, except for the modifications and differences disclosed herein. Further, the carbon dioxide removal device 104 is configured to remove carbon dioxide from the enclosure air A_{E} and is generally similar to the “carbon dioxide removal device 16” described in co-pending PCT Patent Application No. 2004/024951, except for the differences and modifications disclosed herein.

The carbon dioxide removal device 104 basically includes a housing 105 with an interior chamber 106, a primary inlet port 108, a secondary inlet port 109, and a discharge or outlet port 110, each port 108, 109 and 110 being fluidly connected with the removal device chamber 106. A blower or fan 112 is configured to initiate a flow of enclosure air A_{C} into the inlet port 108, through the chamber 106 and out of the outlet port 110, and is preferably operated by a controller 113. Further, a quantity of a reactive material 114 is disposed within the removal device chamber 106 and is configured to remove carbon dioxide from air passing through the material 114 when flowing through the chamber 106. The oxygen generator 102 is fluidly connected with the removal device chamber 106 such that the generated oxygen O flows directly into the removal device chamber 106, then flows out of the removal device outlet port 110 to the enclosure chamber C_{E}. Further, the gas generator 12 is fluidly connected with the removal device chamber 106 such that the pressurizing gas G flows into the removal device chamber 106, then flows out of the removal device outlet port 106 to the enclosure chamber C_{E}. Preferably, the gas generator 12 is fluidly connected with the carbon dioxide removal device 104 through the oxygen generator 102, preferably by means of a tubular fluid line 118 (e.g., a pipe or hose) extending between the release port 16 and an oxygen generator inlet port 124 (described below). Alternatively, the gas generator 12 may be directly fluidly connected (structure not depicted) with the removal device chamber 106.

With this arrangement, the generated oxygen O and pressurizing gas G are mixed together, and with portions of the enclosure air A_{C} flowing through the removal device chamber 106, prior to flowing into the enclosure chamber C_{E}. As such, exposure of a user to highly concentrated oxygen O and/or gas G is substantially prevented.

Preferably, the oxygen generator 102 includes a housing 120 having an interior chamber C_{O}, a release or outlet port 122 fluidly connected with the interior chamber C_{O} and fluidly connected with the removal device secondary inlet port 109, preferably through a fluid line 123, and an inlet port 124. A quantity of at least one oxygen-producing material or reactant 126 is removably disposeable within the housing chamber C_{O} and is configured to generate oxygen by spontaneous chemical reaction. The housing .120 is configured such that the oxygen O generated by the reactant 126 flows from the housing chamber C_{O}, through the outlet port 122, into the removal device secondary inlet port 109, and thereafter into the enclosure chamber C_{E}.

Further, the oxygen generator 102 preferably includes at least one feeder device 128 is configured to contain either an amount of the oxygen-producing reactant 126, or a reaction initiating/rate-modifying material or “catalyst” 127 to respectively initiate or modify the chemical reaction thereof, and to controllably feed either material 126, 127 into the housing chamber C_{O}. An oxygen sensor 130 is configured to sense a level or amount of oxygen within the enclosure air A_{C} and a controller 132 is coupled with the sensor 130 and is operatively connected with the at least one feeder device 128. The controller 132 is configured to operate the feeder device 128 to supply the reactant 126 or catalyst 127 to the housing chamber C_{O} when a value of sensed oxygen level is less than a predetermined minimum value. Additionally, the controller 132 is preferably further configured to cease operation of the feeder device 128, so as to stop the supply of reactant 126 or catalyst 127 to the generator chamber C_{O}, when the sensed oxygen level value is greater than a predetermined maximum value.

Most preferably, the oxygen reactor 102 includes a first feeder device 140A configured to controllably supply the oxygen-producing reactant 126 to the chamber C_{O} and a second feeder device 140B configured to controllably supply the catalyst 127 to the chamber C_{O}. Preferably, the oxygen producing reactant 126 is sodium percarbonate provided as a particulate mass and the first feeder device 140A is a “solid material” feeder device that includes a housing 142, preferably a hopper 143, with a chamber 145 configured to retain the particulate reactant 126 and having an opening 144 extending into the feeder chamber 145, as best shown in FIG. 6. A rotatable auger 146 is disposed at least partially within the feeder chamber 145 and is configured to displace a portion of the reactant 146 toward or through the feeder opening 144. Further, a motor 148 is operatively connected with the auger 136 and is configured to rotate the auger 146 to controllably supply reactant 126 to the oxygen generator chamber CO, as described above with the feeder device 18. Most preferably, the solid or particulate feeder 140A is a Volumetric Screw Feeder Model SF108-00 commercially available from Systems Engineering & Manufacturing of Oakdale, Calif., but may alternatively be provided by any other appropriate particulate feeder device. Further, the controller 132 or a separate, first controller 133A, preferably a PLC in either case, is electrically coupled with the motor 148, either directly or through a relay (not shown). Alternatively, the controller 132 may be incorporated into the oxygen level sensor 130, such that the sensor/controller 130 directly operates the motor 148.

Further, the catalyst 127 is preferably a liquid solution consisting of water and at least one of the following substances dissolved in the water: manganese acetate tetrahydrate, iron-tetra amido macrocylic ligand, magnesium dioxide, and cellulose. As such, the second feeder 140B is preferably a liquid feeder device that includes a housing 150, preferably a tank 151, with a chamber 152 configured to contain the catalyst 127 and a port 154 extending into the feeder chamber 152. A valve 156 is configured to control flow through the port 154 so as controllably supply catalyst 127 to the oxygen generator chamber C_{O}. The port 154 is preferably located with respect to the generator housing chamber C_{O} such that fluid catalyst 127 flows out the port 154 and is gravity fed (i.e., falls) into the chamber C_{O}. The valve 156 may be an electromechanical valve (as shown in FIG. 2), preferably a latching solenoid valve, or a manually-operated valve (as shown in FIG. 1) any other electromechanical valve (e.g., a motor-driven spindle valve). Further, either the single controller 132 or a separate, second controller 133B, preferably a PLC, is electrically coupled with the electromechanical valve 156, as shown in FIG. 2, either directly or through a relay (not shown), although the controller 132 may be incorporated into the oxygen sensor 130, such that the sensor 20 operates the valve 38 to supply catalyst 127 when required, as discussed above.

Furthermore, in one embodiment shown in FIG. 2, the oxygen generator 102 includes both a particulate feeder device 140A operated by the controller 132 to automatically and controllably supply the oxygen-producing reactant 126 and a second liquid feeder device 140 configured to supply the catalyst 127 as manually controlled by a user (i.e., operating the valve 156). In a second embodiment shown in FIG. 3, the oxygen generator only includes a liquid feeder device 140B operated by the controller 132 to automatically and controllably supply the catalyst 127, with the oxygen-producing reactant 126 being manually supplied by a user (e.g., manually poured into chamber C_{G}).

Additionally, the one or more controllers 132 of the oxygen generator 102 are preferably coupled with the controller 22 of the gas generator feeder device 18, such the one or more oxygen generator feeder devices 128 are operated when the gas generator feeder devices 18 are operated. As such, oxygen O is generated whenever the gas generator 12 generates the pressurizing gas G. Further, the fan controller 113 is preferably coupled with at least the controller 132 of at least one oxygen generator feeder device 128, such the enclosure air A_{C} flows through the carbon dioxide removal device 104 whenever the one or two oxygen generator feeder devices 128 is/are operated. Thereby, enclosure air A_{C} is “circulated” through the removal device 104 whenever oxygen O is generated by the oxygen generator 102.

With the air treatment systems 100 of FIGS. 2 and 3, the mixture M of pressurizing gas G and undesired gas/solid RP₂ generated within the gas generator chamber C_{G} flows out the release port 16, through fluid line 46 and into the reaction product removal device 40. The “filtered” pressurizing gas G then flows out the removal device discharge port 45, through fluid line 47, and into the oxygen generator inlet port 124. The gas G mixes with oxygen O disposed within the oxygen generator chamber CO and a gas/oxygen mixture GO flows out the oxygen generator release port 122, through the tubular fluid line 123 and into the secondary inlet 109 of the carbon dioxide removal device 104. The gas/oxygen mixture GO then mixes with enclosure air A_{C} flowing through the removal device chamber 104, preferably after removal of carbon-dioxide therefrom, such that a well-mixed gas GOA including enclosure air A_{C}, oxygen O and pressurizing gas G is discharged from the removal device chamber 106 through the outlet 110 and into the enclosure chamber E_{C}. With the treatment systems 100 of FIGS. 4 and 5, either the gaseous intermediate product R_{I} (FIG. 4) or the gasified base product R_{B} (FIG. 5) flows through flow lines 49, 51, respectively, and into the decomposition device 60. Once decomposed into the preferred oxygen and nitrogen mixture GO, the mixture gas GO is discharged into the enclosure chamber C_{E}.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as described in the appended claims.

I claim:

1. A pressurization device for a flexible enclosure, the enclosure being disposeable within an environment having air at a pressure and configured to define an interior chamber, the chamber having a sufficient volume to entirely contain at least one person and containing air at a pressure, the pressurization device comprising:
a gas generator configured to generate a gas and to release the gas into the enclosure chamber such that the enclosure air pressure is at least one of increased to a value greater than the value of the environment air pressure and maintained at a value greater than the environment air pressure value so as to substantially prevent entry of environment air into the enclosure chamber.

2. The pressurization device as recited in claim 1 wherein the gas generator is configured to generate the gas by a chemical reaction.

3. The pressurization device as recited in claim 1 wherein the gas generator includes a quantity of at least one reactant and is configured to initiate chemical reaction of the reactant so as to generate the gas.

4. The pressurization device as recited in claim 3 wherein the reactant includes at least one of sodium nitrite, sulfamic acid and ammonium chloride.

5. The pressurization device as recited in claim 3 wherein the reactant is a first reactant and the gas generator further includes a quantity of a second reactant, the chemical reaction being initiated when at least a portion of the quantity of first reactant combines with at least a portion of the quantity of second reactant.

6. The pressurization device as recited in claim 5 wherein the first reactant includes sodium nitrite and the second reactant includes one of sulfamic acid and ammonium chloride.

7. The pressurization device as recited in claim 6 wherein the first reactant is a particulate solid and the second reactant is a liquid, the first reactant particulate solid being depositable into the second reactant liquid so as to initiate the chemical reaction.

8. The pressurization device as recited in claim 1 wherein the gas generator is configured to produce an intermediate product and to decompose the intermediate product so as to produce the gas.

9. The pressurization device as recited in claim 8 wherein the intermediate product is nitrous oxide and the gas includes a mixture of oxygen and nitrogen.

10. The pressurization device as recited in claim 1 wherein the gas generator includes a supply of a base substance and is configured to decompose the base substance so as to produce the gas.

11. The pressurization device as recited in claim 10 wherein the base substance is a liquid including nitrous oxide and the gas includes a mixture of oxygen and nitrogen.

12. The pressurization device as recited in claim 1 wherein the gas is one of substantially composed of nitrogen and substantially composed of a mixture of oxygen and nitrogen.

13. The pressurization device as recited in claim 1 wherein the gas generator includes:
a housing having an interior chamber and a release port, the port being fluidly connected with the interior chamber and fluidly communicable with the enclosure chamber; and
a quantity of a reactant removably disposeable within the housing chamber and configured to generate gas by spontaneous chemical reaction, the housing being configured such that the gas generated by the reactant flows from the housing chamber, through the housing opening and into the enclosure chamber.

14. The pressurization device as recited in claim 13 wherein the housing is one of disposed within the enclosure chamber and at least partially disposed within the environment.

15. The pressurization device as recited in claim 13 further comprising a feeder device configured to supply reactant to the generator housing chamber.

16. The pressurization device as recited in claim 15 further comprising:
a pressure sensor configured to sense a difference between the interior air pressure and the exterior air pressure; and
a controller coupled with the sensor and operatively connected with the feeder device such that the controller operates the feeder device to supply reactant to the housing chamber when a value of sensed pressure difference is lesser than a predetermined value.

17. The pressurization device as recited in claim 13 wherein the reactant is a first reactant and the gas generator further comprises a second reactant removably disposed within the housing chamber such that when the first reactant is supplied to the housing chamber, the first reactant mixes with the second reactant to initiate chemical reaction of at least one of the two reactants.

18. The pressurization device as recited in claim 17 wherein:
the first reactant is a particulate mass including at least sodium nitrite; and
the second reactant is a liquid including at least one of ammonium chloride and sulfamic acid.

19. The pressurization device as recited in claim 17 wherein:
the first reactant is a liquid including sodium nitrite; and
the second reactant is. a liquid including at least one of sulfamic acid and ammonium chloride.

20. The pressurization device as recited in claim 15 wherein the reactant is a particulate and the feeder device includes:
a housing with a chamber configured to retain the reactant and having an opening extending into the housing chamber;
a rotatable auger disposed at least partially within the chamber and configured to displace a portion of the reactant at least one of toward the opening and through the opening; and
a motor operatively connected with the auger and configured to rotate the auger to controllably supply reactant to the generator housing chamber.

21. The pressurization device as recited in claim 20 further comprising:
a pressure sensor configured to sense a difference between the interior air pressure and the exterior air pressure; and
a controller coupled with the sensor and operatively connected with the motor such that the motor rotates the auger to supply reactant to the generator housing chamber when a value of sensed pressure difference is lesser than a predetermined value.

22. The pressurization device as recited in claim 15 wherein the reactant is a liquid and the feeder includes:
a housing with a chamber configured to contain the reactant and having a port extending into the feeder chamber; and
an electromechanical valve configured to control flow through the port so as controllably supply reactant to the generator housing chamber.

23. The pressurization device as recited in claim 13 wherein the chemical reaction further generates a byproduct and the gas generator further includes a pump configured to evacuate the byproduct from the housing chamber.

24. The pressurization device as recited in claim 1 wherein:
the gas is a first reaction product and the gas generator is configured to generate a mixture product, the mixture product including the first reaction product and a second reaction product; and
the pressurization device further comprises a removal device coupled with the gas generator such that the gas generator releases the product mixture into the removal device, the removal device being configured to absorb the second reaction product and to release the first reaction product into the enclosure chamber.

25. The pressurization device as recited in claim 1 further comprising a pressure relief device configured to release a portion of the enclosure air into the environment when the enclosure air pressure is greater than a predetermined maximum value.

26. The pressurization device as recited in claim 25 wherein the pressure relief device includes:
two automatic relief valves, each automatic relief valve being adjustable between an open configuration at which air is releasable from the enclosure chamber to the environment and a closed configuration, each valve being configured to automatically adjust to the open configuration when the enclosure pressure is greater than the predetermined maximum value and to adjust to the closed configuration when the enclosure air pressure is lesser than another predetermined pressure value; and
a manual relief valve separately fluidly connected with each one of the two automatic relief valves and adjustable between an open configuration at which each one of the two automatic relief valves is fluidly connected with the enclosure chamber and a closed configuration at which the two automatic relief valves are fluidly disconnected from the enclosure chamber.

27. An air treatment system for an enclosure, the enclosure being disposeable within an environment having air at a pressure and configured to define an interior chamber, the chamber having a sufficient volume to entirely contain at least one person and containing air at a pressure, the air treatment system comprising:
an oxygen generator configured to generate oxygen and to discharge oxygen into the enclosure chamber; and
a gas generator configured to generate a pressurizing gas and to release the gas into the enclosure chamber such that the enclosure air pressure is at least one of increased to a value greater than the value of the environment air pressure and maintained at a value greater than the environment air pressure value so as to substantially prevent entry of environment air into the chamber.

28. The air treatment system as recited in claim 27 further comprising a carbon dioxide removal device configured to remove carbon dioxide from the enclosure air.

29. The air treatment system as recited in claim 28 wherein:
the carbon dioxide removal device includes a housing with an interior chamber, an inlet port, and an outlet port and is configured to initiate a flow of enclosure air into the inlet port, through the chamber and out of the outlet port; and
the oxygen generator is fluidly connected with the removal device chamber such that the generated oxygen flows directly into the removal device chamber and flows out of the removal device outlet port to the enclosure chamber; and
the gas generator is fluidly connected with the removal device chamber such that the pressurizing gas flows into the removal device chamber and flows out of the removal device outlet port to the enclosure chamber.

30. The air treatment system as recited in claim 29 wherein:
the generated oxygen is mixed with enclosure air flowing through the removal device chamber prior to flowing into the enclosure chamber; and
the pressurizing gas is mixed with enclosure air and oxygen flowing through the removal device chamber prior to flowing into the enclosure chamber.

31. The air treatment system as recited in claim 29 wherein:
the carbon dioxide removal device further includes a quantity of a reactive material disposed within the removal device chamber and configured to remove carbon dioxide from air, a fan configured to initiate air flow through the inlet port and out of the outlet port, and a secondary inlet port fluidly connected with removal device chamber;
the oxygen generator includes a housing with an interior chamber, an outlet port fluidly connected with the oxygen generator chamber and with the removal device secondary inlet port, and an inlet port fluidly connected with the generator chamber, a quantity of an oxygen producing material being removably disposeable within the oxygen generator chamber; and
the gas generator includes a housing with an interior chamber and an outlet port fluidly connected with the gas generator chamber and with the oxygen generator inlet port, a quantity of a gas-producing material being removably disposed within the chamber and configured to produce the pressurizing gas.

32. The air treatment system as recited in claim 31 wherein:
pressurizing gas disposed within the gas generator chamber flows out of the gas generator inlet, through the oxygen generator. inlet and into the oxygen generator chamber; and
oxygen and pressurizing gas disposed within the oxygen generator chamber flow out of the oxygen generator outlet port and into the removal device secondary inlet port.

33. An oxygen generator device for a flexible enclosure, the enclosure being disposeable within an environment having air and configured to define an interior chamber, the chamber having a sufficient volume to entirely contain at least one person and containing air, the oxygen generator device comprising:
a housing having an interior chamber and a release port, the port being fluidly connected with the interior chamber and fluidly communicable with the enclosure chamber;
a quantity of an oxygen-producing material removably disposeable within the housing chamber and configured to generate oxygen by spontaneous chemical reaction, the housing being configured such that the oxygen generated by the material flows from the housing chamber, through the housing opening and into the enclosure chamber; and
a feeder device configured to contain an amount of the oxygen-producing material and to controllably feed the material into the housing chamber.
